(19) United States
(12) Patent Application Publication
(10) Pub. No.: US 2011/0154339 A1
(43) Pub. Date: Jun. 23, 2011

(54) INCREMENTAL MAPREDUCE-BASED DISTRIBUTED PARALLEL PROCESSING SYSTEM AND METHOD FOR PROCESSING STREAM DATA

(75) Inventors: Myung-Cheol LEE, Daejeon (KR); Mi-Young Lee, Daejeon (KR)

(73) Assignee: Electronics and Telecommunications Research Institute, Daejeon (KR)

(21) Appl. No.: 12/968,647

(22) Filed: Dec. 15, 2010

(30) Foreign Application Priority Data
Dec. 17, 2009 (KR) 10-2009-0126035

(51) Int. Cl. G06F 9/46; G06F 15/76

(52) U.S. Cl. 718/100; 712/28

(57) ABSTRACT

Disclosed herein is a system for processing large-capacity data in a distributed parallel processing manner based on MapReduce using a plurality of computing nodes. The distributed parallel processing system is configured to provide an incremental MapReduce-based distributed parallel processing function for large-capacity stream data which is being continuously collected even during the performance of the distributed parallel processing, as well as for large-capacity stored data which has been previously collected.

### CROSS REFERENCE TO RELATED APPLICATION

This application claims the benefit of Korean Patent Application No. 10-2009-0126035, filed on Dec. 17, 2009, which is hereby incorporated by reference in its entirety into this application.

### BACKGROUND OF THE INVENTION

1. Technical Field

The present invention relates generally to a system and method for processing stream data, and, more particularly, to a system and method which processes large-capacity data in a distributed parallel manner based on MapReduce using a plurality of computing nodes.

2. Description of the Related Art

With the appearance of Web 2.0, the paradigm of Internet services has moved from service provider-centered services to user-centered services, and thus the markets of Internet services such as User-Created Content (UCC) or personalized services have rapidly increased. Due to such variations in paradigm, the amount of the data that is generated by users and that must be collected, processed and managed for Internet services has rapidly increased.

In order to collect, process and manage such large-capacity data, a plurality of Internet portals has done vast research into the technology for configuring low-cost and large-scale clusters, managing large-capacity data in a distributed manner, and processing jobs in a distributed parallel manner. Of job distributed parallel processing technologies, a MapReduce model by Google Inc. in the United States has attracted attention as a representative job distributed parallel processing method.

The MapReduce model is a distributed parallel processing programming model proposed by Google to support distributed parallel operations on large-capacity data stored on a cluster composed of low-cost and large-scale nodes.

Distributed parallel processing systems based on the MapReduce model may include distributed parallel processing systems such as a MapReduce system by Google and a Hadoop MapReduce system by Apache Software Foundation.

Such a MapReduce model-based distributed parallel processing system basically supports only the periodical offline batch processing of large-capacity data that has been previously collected and stored, and does not especially consider the real-time processing of stream data that is being continuously collected. Accordingly, it is currently required to periodically perform batch processing of newly collected input data.

Further, most Internet portals that use the MapReduce model-based distributed parallel processing systems mainly require data processing jobs such as the job of providing a fast search function to users by constructing indices for Internet data, UCC, or personalized service data which has been collected as large-capacity data in this way, or the job of extracting meaningful statistical information and utilizing such extracted information for marketing purposes.

In general, services which are provided by the Internet portals in this way mainly support similarity-based searching that promptly searches for results approximate to accurate results within an allowable range, rather than accurate searching that searches for accurate results even if a lot of time is required. Accordingly, it can be concluded that the current environment further requires real-time data processing.

Therefore, from the standpoint of Internet portals that provide Internet services, the ability to extract meaningful information from a large amount of stream data, which is collected at very high speed, as fast as possible, and to provide extracted information to users may be the competitive power of businesses. However, it is impossible to realistically perform real-time processing on a large amount of stream data desired by Internet portals using only batch processing-based distributed parallel processing models provided by existing systems.

### SUMMARY OF THE INVENTION

Accordingly, the present invention has been made keeping in mind the above problems occurring in the prior art, and an object of the present invention is to provide a high-speed data processing system and function, which enables high-speed processing approximate to real-time processing by providing technology for the incremental MapReduce-based distributed parallel processing of large-capacity stream data that is being continuously collected.

In accordance with an aspect of the present invention to accomplish the above object, there is provided a distributed parallel processing system, including a stream data monitor for periodically monitoring whether additional data has been collected in an input data storage place, and a job manager for generating one or more additional tasks based on results of the monitoring by the stream data monitor, and outputting new final results by merging final results output from previous tasks with intermediate results generated by the one or more additional tasks.

In accordance with another aspect of the present invention, there is provided a distributed parallel processing method, including generating one or more additional tasks based on results of monitoring of additional data collected in an input data storage place, and merging final results output from previous tasks with intermediate results generated by the one or more additional tasks, thus outputting new final results.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a distributed parallel processing system according to the present invention;

FIG. 2 is a diagram showing an example of the operation of a distributed parallel processing method according to the present invention;

FIG. 3 is a diagram showing an example of the configuration of a directory in which the final results are generated in an output data storage place;

FIG. 4 is a diagram showing an example of a MapReduce programming model according to the present invention;

FIG. 5 is a flowchart showing a procedure for determining whether additional input data has been collected and processing the additional input data;

FIG. 6 is a flowchart showing a method of reducing the number of versions by merging previous final results.

### DESCRIPTION OF THE PREFERRED EMBODIMENTS

In order to sufficiently understand the present invention, the advantages of the operations thereof, and objects achieved by the embodiments of the present invention, the attached drawings illustrating the embodiments of the present invention and the contents described therein should be referred to.

The present invention relates to a method which incrementally provides a distributed parallel processing function even for large-capacity data that is being continuously collected, as well as distributed parallel processing for large-capacity data that has been previously collected and stored, in a job distributed parallel processing system for large-capacity data on a cluster composed of multiple nodes that support a MapReduce-based distributed parallel processing model, thus providing an almost real-time distributed parallel processing function for the large-capacity stream data that is being continuously collected.

Hereinafter, the present invention will be described in detail by describing preferred embodiments of the present invention with reference to the attached drawings. The same reference numerals are used throughout the different drawings to designate the same or similar components.

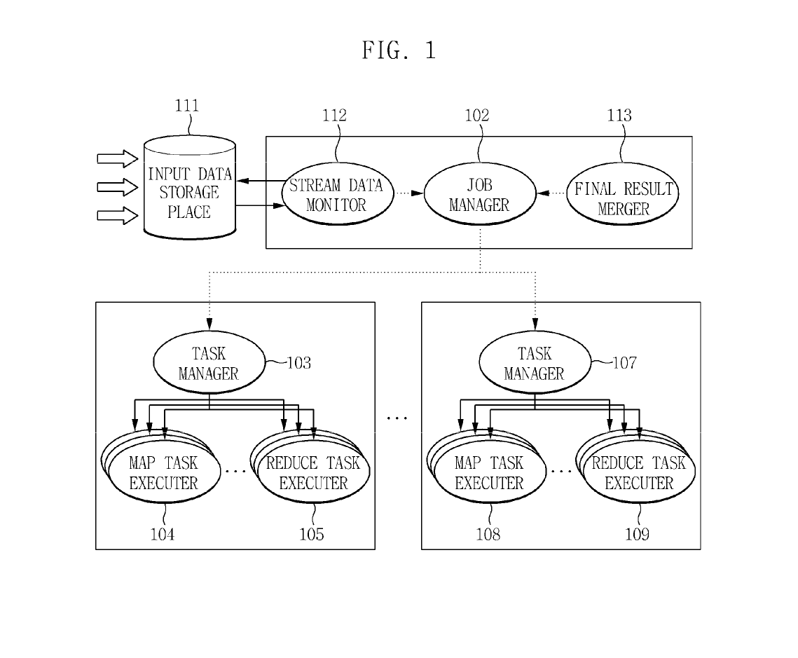

FIG. 1 is a diagram showing the construction of a distributed parallel processing system according to the present invention.

As shown in FIG. 1, the distributed parallel processing system according to the present invention may include a job manager 102, a stream data monitor 112, a final result merger 113, and one or more task managers 103 and 107.

The job manager 102 may be executed by a node which takes charge of job management, and may control and manage the entire job processing procedure.

The stream data monitor 112 may function to periodically examine whether new data has been collected.

The stream data monitor 112 may periodically examine whether new data, that is, additional stream data, has been collected in an input data storage place 111, and notify the job manager 102 of information corresponding to the results of the examination.

In this case, the stream data monitor 112 creates a log file by logging the last time at which new input data was processed, that is, the time at which the processing of input data in a distributed parallel manner by the job manager 102, which will be described later, was completed, in order to manage new data which is input to the input data storage place 111. Further, the stream data monitor 112 may recognize only data, collected in the input data storage place 111 after that time (that is, the processing time), as new data with reference to the created log file.

The job manager 102 may perform control such that on the basis of the notification provided by the stream data monitor 112, one or more additional tasks, for example, new Map tasks and Reduce tasks, are generated and then newly collected additional data can be processed in a distributed parallel manner.

The final result merger 113 may periodically merge various versions of final results to generated by the Reduce tasks.

The final result merger 113 functions to periodically merge various versions of output results into one version of the output result when various versions of output results are stored in the output data storage place, and may notify the job manager 102 of the results of the performance of the merger.

The job manager 102 may provide the location of a relevant file if the final result, which is generated by the merger and is output from the final result merger 113, is present at the time of providing the results of the previous performance when a new Reduce task is generated.

Each of the one or more task managers 103 and 107 may include a plurality of Map task executers 104 or 108 that actually execute a plurality of Map tasks allocated to a corresponding task manager, and a plurality of Reduce task executers 105 or 109 that actually execute a plurality of Reduce tasks.

The Map task executers 104 and 108 or the Reduce task executers 105 and 109 may be generated during a procedure for allocating and executing Map tasks or Reduce tasks. After the tasks have been executed, those executers may be deleted from the memory.

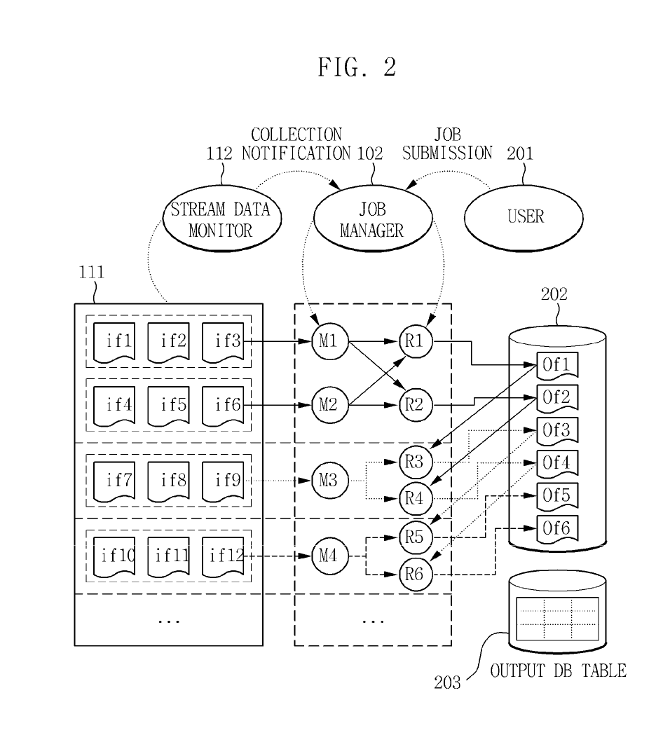

A method of providing an incremental MapReduce-based distributed parallel processing service for processing stream data, which is proposed in the present invention, is shown in FIG. 2.

FIG. 2 is a diagram showing an example of the operation of a distributed parallel processing method according to the present invention.

Referring to FIG. 2, a user 201 presents a MapReduce-based distributed parallel processing job, which includes ‘input data storage place’, ‘output data storage place’, ‘user-defined Map function’, ‘user-defined Reduce function’, ‘user-defined Update function’, ‘the number of Reduce tasks’, ‘determination of whether to delete processed input’, ‘job execution termination time’, etc., to the job manager 102, and then requests distributed parallel processing from the job manager 102.

The job manager 102 reads a file list stored in the input data storage place 111, calculates the size of the entire input data, generates a suitable number of Map tasks M1 and M2, and allocates the Map tasks M1 and M2 to the Map task executers of a task execution node to allow the Map tasks to be processed.

Further, the job manager 102 generates Reduce tasks R1 and R2 the number of which is identical to the number of Reduce tasks input by the user, and allocates the Reduce tasks to the Reduce task executers of the task execution node to allow the Reduce tasks to be processed.

The Map tasks M1 and M2 process allocated input files and generate intermediate resulting files.

In this case, the intermediate results generated by the respective Map tasks are uniformly distributed to a plurality of Reduce tasks depending on the partition function registered by the user.

The Reduce tasks R1 and R2, which copy the intermediate results from the respective Map tasks, configure the final results obtained after having been processed in the form of files of1 and of2 in the output data storage place 215 specified by the user, or insert the final results into an output database (DB) table 203.

The stream data monitor 112 periodically monitors whether additional files have been collected, in addition to input files that are currently being processed, in the input data storage place 111.

If a suitable amount of new input data has been collected as a result of the monitoring, the stream data monitor 112 notifies the job manager 102 of the collection of the new input data. The job manager 102 generates a new Map task M3 for processing the relevant additional input files, allocates the new Map task M3 to the Map task executer of the task execution node, and then allows the new Map task M3 to be processed.

Further, the job manager 102 generates Reduce tasks R3 and R4 for processing the intermediate results of the Map task M3, allocates the Reduce tasks R3 and R4 to the Reduce task executers of the task execution node, and then allows the Reduce tasks R3 and R4 to be processed.

In this case, the newly generated Reduce tasks R3 and R4 are generated such that the number of the newly generated Reduce tasks is identical to the number of previous Reduce tasks R1 and R2.

The previous Reduce tasks R1 and R2 generate primary final results on the basis of the intermediate result files generated by the previous Map tasks M1 and M2, and configure the primary final results in the form of files of1 and of2, respectively, of an output data storage place 202, or insert and store the primary final results into the output DB table 203.

Thereafter, when the new Map task M3 is generated, the new Reduce tasks R3 and R4 combine the intermediate results generated by the Map task M3 with the previous final results of1 and of2, which were generated by the previous Reduce tasks R1 and R2 on the basis of the intermediate results generated by the previous Map tasks M1 and M2, thus generating new final results of3 and of4. The new final results of3 and of4 are configured in the form of files of3 and of4, respectively, of the output data storage place 202 or are inserted and stored into the output DB table 203.

Further, the above procedures may be repeatedly performed whenever new data, that is, each additional file, is collected in the input data storage place 111, so that an incremental MapReduce-based distributed parallel processing function for processing stream data that is being continuously collected can be provided.

For example, the stream data monitor 112 monitors whether additional files have been collected in the input data storage place 111. If new input data has been collected as a result of the monitoring, the stream data monitor 112 notifies the job manager 102 of the collection of the new input data. The job manager 102 generates a new Map task M4 for processing the relevant additional input files, and allocates the Map task M4 to the Map task executer of the task execution node to allow the Map task M4 to be processed.

Further, the job manager 102 generates Reduce tasks R5 and R6 for processing the intermediate results of the Map task M4, and allocates the Reduce tasks R5 and R6 to the Reduce task executers of the task execution node to allow the tasks R5 and R6 to be processed.

In this case, the new Reduce tasks R5 and R6 are generated such that the number of the new Reduce tasks is identical to the number of the previous Reduce tasks R1 and R2 or R3 and R4.

The new Reduce tasks R5 and R6 combine the intermediate results generated by the Map task M4 with previous final results of3 and of4, which were generated by the previous Reduce tasks R3 and R4 on the basis of the intermediate results generated by the previous Map task M3, thus generating new final results of5 and of6. The new final results of5 and of6 are configured in the form of files of5 and of6, respectively, of the output data storage place 202 or are inserted and stored into the output DB table 203.

Meanwhile, the previous Map tasks M1 and M2 and the Reduce tasks R1 and R2 may be terminated immediately after the processing of the allocated input data has finished.

Further, the new Map tasks M3 and the Reduce tasks R3 and R4 may also be terminated immediately after the processing of newly collected input data if7, if8, and if9 has finished.

The new Map task M3 independently starts processing regardless of whether the previous Map tasks M1 and M2 have been processed, and the new Map task M4 independently start processing regardless of whether the previous Map tasks M1, M2, and M3 have been processed.

However, since the new Reduce tasks R3 and R4 are executed by receiving the intermediate results of the Map task M3 related thereto and receiving the previous final results generated by the previous Reduce tasks R1 and R2, they always start processing after the Map task M3 and the previous Reduce tasks R1 and R2 have been executed.

Further, since the new Reduce tasks R5 and R6 are executed by receiving the intermediate results of the Map task M4 related thereto and receiving the previous final results generated by the previous Reduce tasks R3 and R4, they always start processing after Map task M4 and the previous Reduce tasks R3 and R4 have been executed.

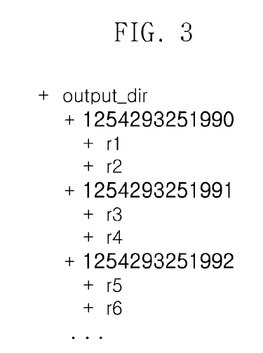

The configuration of a directory in which the Reduce tasks R1, R2, R3, R4, R5, and R6 generate the final results in the output data storage place will be described below. That is, the directory has a configuration as shown in FIG. 3.

FIG. 3 is a diagram showing an example of the configuration of the directory in which the final results are generated in the output data storage place.

Referring to FIG. 3, when the output data storage place 202 provided when the user presents a job is ‘output_dir’, the storage places of the Reduce tasks R1 and R2 that were executed at the time when the job was initially presented are the directories ‘output_dir/1254293251990/r1’ and ‘output_dir/1254293251990/r2’, respectively, under the directory ‘output_dir/1254293251990’ representing timestamp values indicating the time point of the first execution.

Thereafter, the final results of the Reduce tasks R3 and R4 that were executed second are stored under the directory ‘output_dir/1254293251991’ indicating the time point of the second execution.

Further, the final results of the Reduce tasks R5 and R6 that were executed third are stored under the directory ‘output_dir/1254293251992’ indicating the time point of the third execution, and thus the latest data may be stored in the directory having the largest timestamp value.

Further, the final result merger 113 (refer to FIG. 1) may periodically merge various versions of final results and may store the final results in the directory indicating the time point of the relevant merger.

In this case, the previous versions of final results are deleted, and the newly generated final results are used as the previous final results for Reduce tasks that will be subsequently executed.

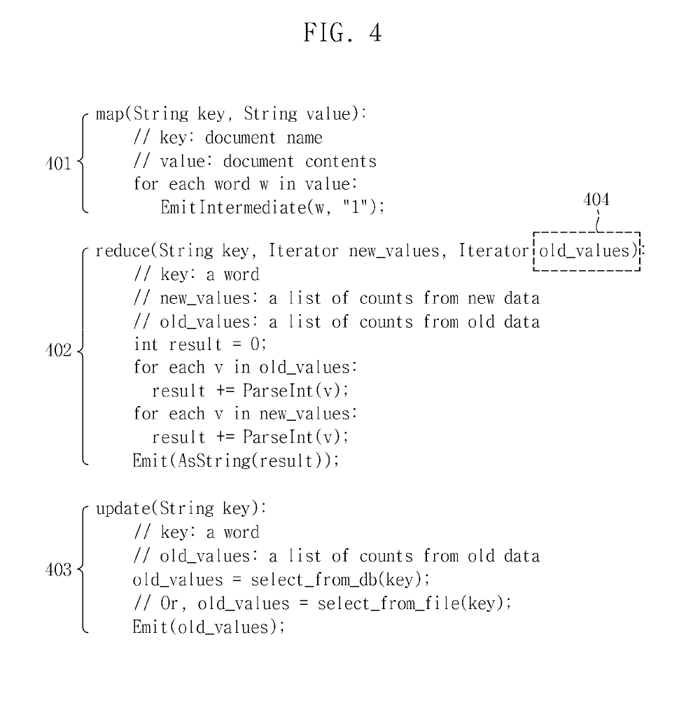

FIG. 4 is a diagram showing an example of a MapReduce programming model according to the present invention.

As shown in FIG. 4, the MapReduce programming model according to the present invention includes a user-defined Map function 401, a user-defined Reduce function 402, and a user-defined Update function 403.

For the incremental MapReduce-based distributed parallel processing service for processing stream data, a program created by the user based on the MapReduce programming model according to the present invention can be provided.

The MapReduce programming model according to the present invention is a programming model for adding the Update function 403 to the conventional MapReduce programming model provided by Google so that the user can specify a method of retrieving the previous (old) results of the processing of the Reduce function 402, and for adding an old_values factor 404 thereto so that the results of the Update function 403 are transferred to the Reduce function.

A distributed parallel processing job complying with the MapReduce programming model according to the present invention may be basically performed on the assumption that the previous results are present, and a method of retrieving values from a previous result file or a previous result DB must be provided by the user in the Update function.

In this case, unless the user provides the Update function, the Reduce function of the MapReduce programming model does not know the previous result value of the execution of the Reduce function, so that it is always determined that previous result values are not present, and thus new result values are overwritten in the file or the DB.

Therefore, the MapReduce programming model according to the present invention allows the user to create an Update function and describe a method of obtaining previous results. Whenever a Reduce function is called, an Update function corresponding to a relevant key is executed within Reduce task executers to obtain previous result values old_values, and thereafter those values can be provided as the input of the Reduce function.

In this case, when the final results are related to a file, the Update function created by the user can retrieve the results of the relevant key value to date from the file. Further, when the final results are related to a DB table, the Update function can search the DB table for a row corresponding to the key value and can retrieve the value of the row from the DB table.

At the time point at which the MapReduce job is presented, the user provides information about an input data storage place, in which stream data is stored, to the job manager, and thereafter all stream data is incrementally collected in the input data storage place in the form of each individual file. Hereinafter, a procedure for determining whether additional input data has been collected and processing collected additional input data in the incremental MapReduce-based distributed parallel processing system for processing stream data according to the present invention will be described.

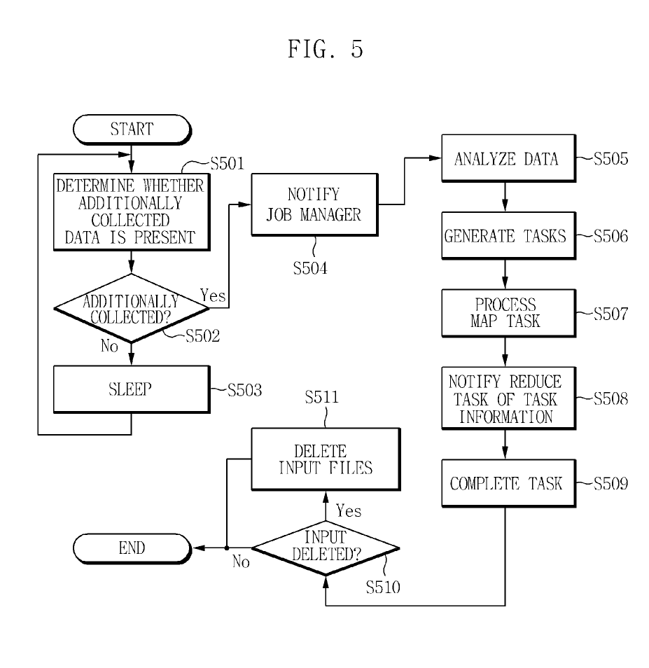

FIG. 5 is a flowchart showing a procedure for determining whether additional input data has been collected and processing the additional input data.

Referring to FIGS. 2 and 5, the stream data monitor 112 may periodically determine whether additionally collected data is present in the input data storage place 111 at steps S501 and S502.

In this case, if additionally collected data is not present (in the case of “No”), the stream data monitor 112 sleeps for a predetermined period at step S503, and determines again whether additionally collected data is present at steps S501 and S502.

If it is determined that additionally collected data is present (in the case of “Yes”), the stream data monitor 112 notifies the job manager 102 of the additionally collected data at step S504, sleeps for a predetermined period, and then repeats the determining operation.

The job manager 102 analyzes the additionally collected data at step S505, determines the number of pieces of data and the capacity of the data, generates a number of Map tasks suitable for the processing of the input data, and newly generates Reduce tasks the number of which is identical to the number of previous Reduce tasks at step S506.

The generated Map tasks may be allocated to and processed by the Map task executers of the task execution node according to the scheduling of the job manager 102 at step S507, and the generated Reduce tasks may be allocated to and processed by the Reduce task executers of the task execution node according to the scheduling of the job manager 102.

Information about the execution of the generated Map tasks, information about the locations of intermediate results to be generated by the Map tasks, information about the locations of the final execution results of the previous Reduce tasks, etc. can be provided to the generated Reduce tasks at step S508.

When the generated Map tasks has been executed at step S509, the intermediate results generated by the Map tasks are copied to and processed by new Reduce tasks.

Further, when the user desires to delete the input of the Map tasks which have been executed at step S510, the job manager 102 deletes relevant input files, and completes the deletion at step S511.

Meanwhile, the distributed parallel processing system according to the present invention is configured such that as new stream data is collected, Reduce tasks are newly generated several times, and new final results are generated with reference to the previous final results. Accordingly, as time has elapsed, various versions of final results, that is, a large number of final results, are accumulated in the output data storage place.

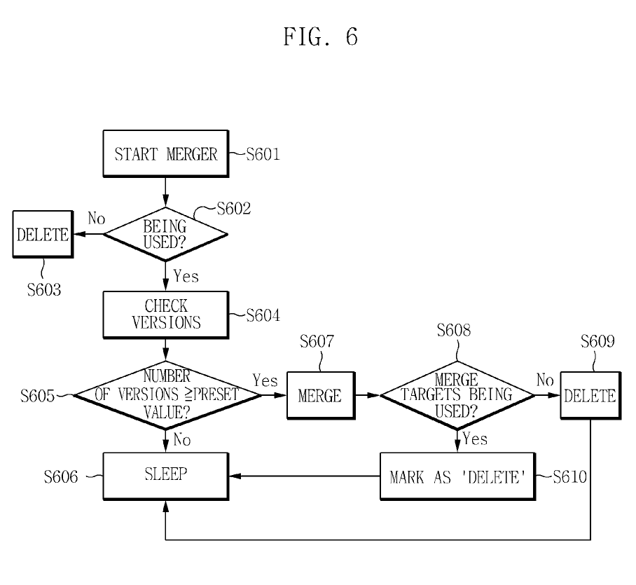

Therefore, the final result merger 113 of FIG. 1 merges the previous final results according to the procedure shown in FIG. 6, thus providing a method of reducing the number of versions.

FIG. 6 is a flowchart showing a method of merging the final results and reducing the number of versions.

Referring to FIGS. 1, 2 and 6, when the merger of the final results starts at step S601, the final result merger 113 determines whether previous versions of final results marked as ‘delete’ are currently being used at step S602. If it is determined that the previous versions of final results are not currently being used (“No”), the previous versions of final results are deleted at step S603.

However, if it is determined that the previous versions of final results are currently being used (“Yes”), the number of versions of the final results located in the output data storage place 202 is checked at step S604. In this case, the versions marked as ‘delete’ may be excluded from calculation.

Further, the checked number of versions is compared to a preset value at step S605. Here, the preset value may denote the number of versions preset by the user.

As a result of the comparison, if the number of versions is less than the preset value (“No”), the final result merger sleeps for a predetermine period at step S606, and then returns to the final result merger start step S601.

In contrast, as a result of the comparison, if the number of versions is equal to or greater than the preset value (“Yes”), the final result merger 113 merges the previous versions of final results to generate a single new version of final results, and stores the new version of final results in a directory having a timestamp value indicating the time point of the generation at step S607.

Then, it is determined whether the previous versions of final results to be merged are currently being used as the previous final results of Reduce tasks that are currently being executed at step S608.

If it is determined that the previous versions of final results are not currently being used, they are deleted at step S609, whereas if it is determined that they are currently being used, they are marked as ‘delete’ at step S610. Thereafter, the final result merger 113 sleeps for a predetermined period at step S606, and then returns to the final result merger start step S601.

The formats of input data and output data supported by the incremental MapReduce-based distributed parallel processing service for processing stream data according to the present invention are shown in the following Table 1.

TABLE 1

Output data

| | | File | DB |
|---|---|---|---|
| Input data | File | ◯ | ◯ |
| | DB | X | X |

In the MapReduce-based distributed parallel processing system for processing stream data according to the present invention, when input data is in DB format, there is no method of distinguishing previously stored data from newly collected data, and thus a DB is not considered to be in input data format.

When the input data is in file format, all input files collected in the input data storage place are basically kept at their original locations without change. When the user desires to delete files which have already been processed at the time of presenting a job, an option enabling the files to be deleted can be provided.

When the user desires to delete the input files of tasks which have been processed, the job manager deletes files which have been processed as input data (input files for which Map tasks have been executed and Reduce tasks retrieve all of the intermediate results of the relevant Map tasks and complete the processing of the intermediate results, and which have been stored in the final result file or DB). Accordingly, if only the input file list of tasks that are currently being executed is maintained, newly collected files can be distinguished from previous files, and thus a distinguishing operation can be simplified.

If all input files must be maintained when the user desires to maintain the input files of tasks that have been processed, the job manager may consume a lot of cost in finding newly collected files from the list of all files. Accordingly, in this case, the present invention uses a method of logging the last time at which the newly collected input files were processed, and recognizing only files, which are generated after the last time, as newly collected files.

The job presented by the user as an incremental MapReduce job can be continuously operated for an infinite period unless the user explicitly stops the job using an Application Programming Interface (API) or specifies a specific termination time in the settings at the time that the job is presented. In this case, even if the MapReduce job is infinitely performed, all of Map tasks and Reduce tasks generated in the MapReduce job are terminated immediately after the processing of input data to be processed has finished.

In the above-described MapReduce programming model, a Combiner step may be added according to the user's selection, in addition to the Map/Reduce steps, wherein processing is performed in the sequence of the Map step, the Combiner step, and the Reduce step. In this case, the Map step and the Combiner step are performed by a Map task execution node, and the Reduce step is performed by a Reduce task execution node. Generally, the Combiner step uses the same class as the Reduce step.

In the incremental MapReduce-based distributed parallel processing system for processing stream data according to the present invention, whenever data is continuously input, Map tasks are newly generated and executed. In this case, the Combiner step registered by the user is subsequently performed after the Map step, and the output of the Combiner step is subsequently transferred to the Reduce step. In this case, the user-defined Update function is not executed at the Combiner step.

As described above, in the MapReduce-based distributed parallel processing system according to the present invention, Reduce tasks are basically operated on the assumption that previous results are present, so that an efficient distributed parallel processing function can be provided in limited environments, which will be described later.

For example, the distributed parallel processing system of the present invention can provide a powerful distributed parallel processing function if 1) the number of Reduce tasks does not influence the final results, 2) the execution results of the Reduce function use the same key as that of the input of the Reduce function, or 3) real-time distributed parallel processing is required for the processing of continuously collected stream data, rather than for accurate results.

As described above, by the distributed parallel processing system and method according to the present invention, the following advantages can be expected.

First, high-speed data processing approximate to real-time processing can be performed.

Second, continuously collected streams can be processed.

Third, large-capacity stream data can be processed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the scope of the present invention should be defined by the technical spirit of the accompanying claims.

What is claimed is:

1. A distributed parallel processing system, comprising:
a stream data monitor for periodically monitoring whether additional data has been collected in an input data storage place; and
a job manager for generating one or more additional tasks based on results of the monitoring by the stream data monitor, and then merging a final result output from a previous task with an intermediate result generated by the one or more additional tasks to output a new final result.

2. The distributed parallel processing system of claim 1, wherein the job manager generates:
a Map task for processing the additional data and outputting the intermediate result; and
one or more Reduce tasks for processing the intermediate result output from the Map task,
wherein the number of the generated Reduce tasks is identical to the number of previous Reduce tasks.

3. The distributed parallel processing system of claim 2, wherein the one or more Reduce tasks output the new final result by merging the intermediate result output from the Map task with the final result output from the previous Reduce task

4. The distributed parallel processing system of claim 2, wherein the Map task is executed independently of previous Map tasks.

5. The distributed parallel processing system of claim 2, wherein the one or more Reduce tasks are executed after the Map task or the previous Reduce task has been executed.

6. The distributed parallel processing system of claim 1, wherein the stream data monitor creates a log file based on a processing time of the additional data collected in the input data storage place, and recognizes data, collected after the processing time, as the additional data with reference to the log file.

7. The distributed parallel processing system of claim 1, further comprising a final result merger for periodically merging final results generated by the additional tasks or the previous task.

8. The distributed parallel processing system of claim 1, further comprising one or more task managers for managing executions of the additional tasks or the previous task

9. A distributed parallel processing method, comprising:
generating one or more additional tasks based on results of monitoring of additional data collected in an input data storage place; and
merging a final result output from a previous task with an intermediate result generated by the one or more additional tasks to output a new final result

10. The distributed parallel processing method of claim 9, wherein the generating the one or more additional tasks comprises:
generating a Map task for processing the additional data and outputting the intermediate result; and
generating one or more Reduce tasks for processing the intermediate result output from the Map task so that the number of generated Reduce tasks is identical to the number of previous Reduce tasks.

11. The distributed parallel processing method of claim 10, wherein the outputting the new final result comprises:
processing the additional data to output the intermediate result, using the Map task; and
merging the intermediate result output from the Map task with the final result output from a previous Reduce task to output the new final result, using the Reduce tasks.

12. The distributed parallel processing method of claim 9, further comprising outputting a single final result by periodically merging final results output from the previous tasks with the new final results output from the additional tasks.

13. The distributed parallel processing method of claim 12, wherein the outputting the single final result comprises:
comparing the number of one or more final results output from the previous tasks or the additional tasks with a preset value; and
merging the one or more final results or sleeping for a predetermined period, based on results of the comparison.

14. The distributed parallel processing method of claim 13, wherein the outputting the single final result is configured to sleep for the predetermined period when the number of the one or more final results is less than the preset value.

15. The distributed parallel processing method of claim 13, wherein the outputting the single final result is configured to merge the one or more final results when the number of the one or more final results is equal to or greater than the preset value.

16. The distributed parallel processing method of claim 9, further comprising creating a log file based on a processing time of the collected additional data, and recognizing data, collected after the processing time, as the additional data.
